(19) United States
(12) Patent Application Publication
(10) Pub. No.: US 2002/0198796 A1
(43) Pub. Date: Dec. 26, 2002

(54) Methods of increasing debt collection

(76) Inventors: R. Douglas White, Ashland, VA (US); Shawn P. Sweeney, Glen Allen, VA (US)

Correspondence Address: BAKER & MCKENZIE, 805 THIRD AVENUE, NEW YORK, NY, 10022, US

(21) Appl. No.: 09/886,363

(22) Filed: Jun. 21, 2001

(51) Int. Cl. G06F 17/60

(52) U.S. Cl. 705/34; 705/39

(57) ABSTRACT

A computer collection model of charged off credit card debt is used to determine the amount and types of commission that should be paid to collection entities and to determine whether and when certain deals should be offered on the debt. The commissions can be plural consecutive percentage commission rates, progressively larger retroactive commission rates, a periodic percentage commission rate resulting in equal profits per period, a fixed collector profit, or another commission arrangement. The model can be designed to maximize at least liquidation rates and/or profitability.

### FIELD OF THE INVENTION

The present invention relates generally to debt collection, and more particularly to effectively managing debt collection agents so as to realize greater value from a given set of debt.

### BACKGROUND

Credit card holders are provided credit by the credit card industry. Some of the credit card holders invariably become delinquent. The credit card companies have had to handle these delinquent accounts on a regular basis and have developed sophisticated method of doing so. (For example, U.S. Pat. No. 6,098,052 which is incorporated herein by reference.) Nonetheless, some of delinquent credit card holders still default. The accounts of the defaulting credit card holders are charged off accounts receivable after a certain period of time (e.g., six months) and closed. Credit card companies generally have relied on collection agencies/agents to collect on these charged off accounts. The collection agency/agent traditionally receives a fixed percentage of the successfully collected charged off debt, commonly called paper, as payment for their services. This percentage or commission is a primary influence credit card companies have upon the collection agencies/agents. Consequently, credit card companies have not become, nor had a need to become, sophisticated in their handling charged off accounts and the debt collectors who collect on those accounts.

Another reason credit card companies have given little attention to this area, and thus have not maximized their return is that credit card companies have treated collections as a customer service function and measured the abandoned rate (The abandoned rate is the percentage of charged off account holder telephone hang ups for telephone calls which resulted from a prior contact by the credit card company with the charged off account holder. Telephone calls lasting five or less seconds are not included in calculating the abandoned rate.) and customer satisfaction to determine success. Credit card companies often outsource these collections to a collection agency/agent, making efficient collections the problem of the agency/agent. The more successful agencies/agents are able to recover more money on a given batch of paper. As a reward, these successful agencies/agents are given additional batches of paper to work. The more successful agencies/agents that have larger batches of paper to work are able to focus on the less worked newer paper that produces a higher return and can collect larger amounts of money for a given amount of effort. The commissions received from successful collections motivate the agencies/agents and have led agencies/agents to unnecessarily better deals to dispose of the paper more quickly. This naturally reduces the abandoned rate and increases customer satisfaction. Thus, the debtors, agencies/agents and credit card companies traditionally have been happy.

Unfortunately, the financial interests of credit card companies are poorly served by this motivation of the collection agencies/agents that can result in a reduced percent of debt collected or liquidation rate. The liquidation rate and other indicators are used by Wall Street to determine the worth and credit worthiness of the credit card companies. Wall Street punishes lower liquidation rate credit card companies with lower stock prices and lower credit ratings.

Accordingly, there is a strong need for credit card companies and other debt owners to efficiently increase their liquidation rate.

### SUMMARY OF THE INVENTION

An aspect of the invention provides for method for increasing collections from a set of debt including determining a collection model for a set of debt owed by a set of debtors, approximating of a cost of debt collection and setting plural commission rates payable to a collection entity for the set of debt. The plural commission rates are set in accordance with the cost of debt collection and the collection model of the set of debt.

Another aspect of the invention provides for a method for increasing collections from a set of debt including determining a collection model for a set of debt owed by a set of debtors, determining an approximate cost of debt collection, and selecting a compensation package from a plurality of compensation packages payable to a collection entity for the set of debt in accordance with the approximate cost of debt collection and the collection model of the set of debt.

A further aspect of the invention provides for computer implemented system for increasing collections from a set of debt including inputting a collection model for a set of debt owed by a set of debtors into a computer, inputting an approximate cost of debt collection into the computer, performing a calculation to determine plural commission rates payable to a collection entity for the set of debt in accordance with a cost of collecting the set of debt and the collection model of the set of debt using the computer, and outputting the plural commission rates.

A further aspect of the invention provides for a method for increasing collections from a set of charged off credit card accounts using a computer including determining a collection model for a set of charged off credit card accounts owed by a set of credit card holders, determining an approximate cost for collection of the charged off credit card accounts and setting plural commission rates payable to a collection agency for the set of charged off credit card accounts. The plural commission rates are set in accordance with the cost of charged off credit card account collection and the collection model of the set of charged off credit card accounts.

A further aspect of the invention provides for a method for increasing collections from a set of charged off credit card accounts using a computer including determining a collection model for a set of charged off credit card accounts owed by a set of credit card holders, determining an approximate cost of charged off credit card account collection and selecting a compensation package from a plurality of compensation packages payable to a collection entity for the set of charged off credit card accounts in accordance with the approximate cost of charged off credit card account collection and the collection model of the set of charged off credit card accounts. The selecting a compensation package selects one or more of a fix profit package, a single commission rate package and a plural commission rate package.

A further aspect of the invention provides for a computer implemented system for increasing collections from a set of charged off credit card accounts including inputting a collection model for a set of charged off credit card accounts owed by a set of charged off credit card account holder into a computer, inputting an approximate cost of charged off credit card account collection into the computer, performing a calculation to determine plural commission rates payable to a collection entity for the set of charged off credit card accounts in accordance with a cost of collecting the set of charged off credit card accounts and the collection model of the set of charged off credit card accounts using the computer and outputting the plural commission rates.

### BRIEF DESCRIPTION OF THE DRAWINGS

FIG. 1 is a simplified graphical model of the predicted collection of debt or paper in collected dollars over time for a traditional single percentage commission rate;

FIG. 2 is a simplified graphical model of the predicted collection of paper over time where first and second consecutive percentage commission rates;

FIG. 3 is a simplified graphical model of the predicted collection of paper over time where the first commission rate is retroactively replaced with progressively larger retroactive commission rates;

FIG. 4 is a simplified graphical model of the predicted collection of paper over time with a period percentage commission rate resulting in equal profits per period;

FIG. 5 is a simplified graphical model of the predicted collection of paper over time with a fixed collector profit;

FIG. 6 is a simplified graphical model of the predicted collection of paper over time with an increasing total dollar commission with time; and

FIG. 7 is a simplified graphical model of the predicted collection of paper over time where an agency/agent is instructed when to make certain deals to increase the total amount of collectable paper.

### DETAILED DESCRIPTION

In the drawings, like reference numerals designate like parts.

Debt collection on charged off accounts can be increased in a number of ways. A first way is to provide an incentive to the collection agencies/agents to work the charged off debt or paper for a longer period of time. Another way is to directly control how long the paper is worked by providing a fixed profit margin. Yet another way is to better control the deals made with the debtor to increase the amount of the paper collected for the collection period.

The first step to improving debt collection is to model collection of the paper. Modeling techniques are well known in the credit card industry and other industries. (See e.g., U.S. Pat. No. 6,098,052.) However, there is no one correct model for modeling debt collection. There are simply too many variables, many of which are poorly understood, difficult to quantify or measure. Nor can debt collection modeling be done once and used thereafter. We are always changing as a society and an economy. These changes can be cultural such as changes in the work ethic, can be economic such as upswings or downturns in the economy or can be derived from other places such as a change in the bankruptcy laws.

The modeling process is made more manageable by the segmentation of debt into small groups having similar characteristics and through the use of computers. For example, debtors could be divided into low, medium and high risk groups based upon a credit rating. This credit rating could be determined using data from credit bureaus, internal record keeping or other sources. The paper could be further subdivided according to other factors such as the size of the debt, relative size of the debt to the debtors credit limit, number of payments previously received, whether or not the debtor's telephone number is current, how long the paper has been charged off or other factors.

The paper can be separated into the various segments once a segmentation scheme is decided upon. A segment of paper can then be given to one or more collection agencies/agents for collection. It is preferable to work a portion of the segment of paper internally as a control group to gain a better understanding of the collections. The information derived from collecting the paper is used to model future collection efforts. This process is continuously repeated to update and improve the model.

The model can now be used to show where inefficiency can be eliminated and new revenue can be generated. For example, inefficiencies such as over payment of collection agencies/agents or failure to decide on the best payment method for working the paper. The model can be used to determine how long or intensely the paper should be worked and how much compensation should be provided to the agencies/agent to motivate them to work the paper for a length of time consistent with the credit card or other debt owners objectives. The model can also be used to select the most advantageous collection strategies and the optimal timing for the strategies.

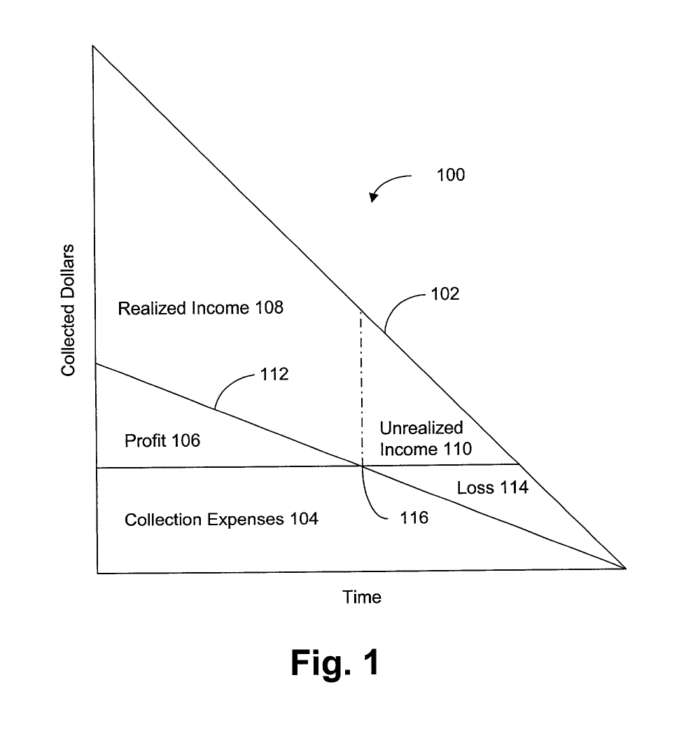

A simplified graphical model 100 of the predicted collection of charged off debt or paper in collected dollars over time for a traditional single percentage commission rate is shown in FIG. 1. The collectable paper 102 can be subdivided into collection expenses 104, profit 106, realized income 108 and unrealized income 110. The collection expenses 104 represent the approximate cost incurred by collection agencies/agents in collecting the paper. This may include salaries, office rentals, telephone charges, postal charges and any other collection related expenses. The collection agency/agent receives a percentage of the collected paper as a commission 112. Any positive difference between the commission 112 and the collection expenses 104 is profit 106 for the collection agency/agent. Any negative difference between the commission 112 and the collection expenses is a loss 114 for the collection agency/agent. The collection expenses 104 equals the commission 112 at a break-even point 116.

The collection agency/agent will begin to have a loss 114 on any collected paper once the break-even point 116 is reached since the commission 112 is insufficient to cover the collection expenses 104. After the break-even point 116, the collection agency/agent has no reason to continue working the paper since this only results in a loss 114. In fact, the collection agency/agent might stop working on the paper prior to the break-even point 116 to work on more profitable paper. Any income that might have been collected after the agency/agent stops working the paper will remain as unrealized income 110. For the sake of simplicity, it is assumed hereinafter that an agency/agent will work the paper to the break-even point 116. However, in practice and in modeling, it must be recognized that the agency/agent would likely work paper that produces the greatest commissions for the time worked. Also, the paper has an inherent value that slowly devalues with time that may be a factor in determining optimal collections. Other optimization include increasing the amount of money collected from the set of debt, maximizing the profitability for an owner of the set of debt, maximizing the amount of money collected from the set of debt less the commissions or other costs, and optimizing the terms, condition and/or timing of settlement offers.

The significant amount of collectable paper 102 left uncollected adversely impacts both the liquidation rate and the profitability of the paper owner. These facts are either unrecognized or ignored by the paper holders and especially credit card companies because paper collection has traditionally treated as a customer service function instead of a source of revenue. Credit card companies often outsource these collections to a collection agency/agent, making efficient collections the problem of the agency/agent. However, it is possible to have the abandoned rate and customer satisfaction within acceptable ranges while increasing the liquidation rate and/or the profitability of the paper owner.

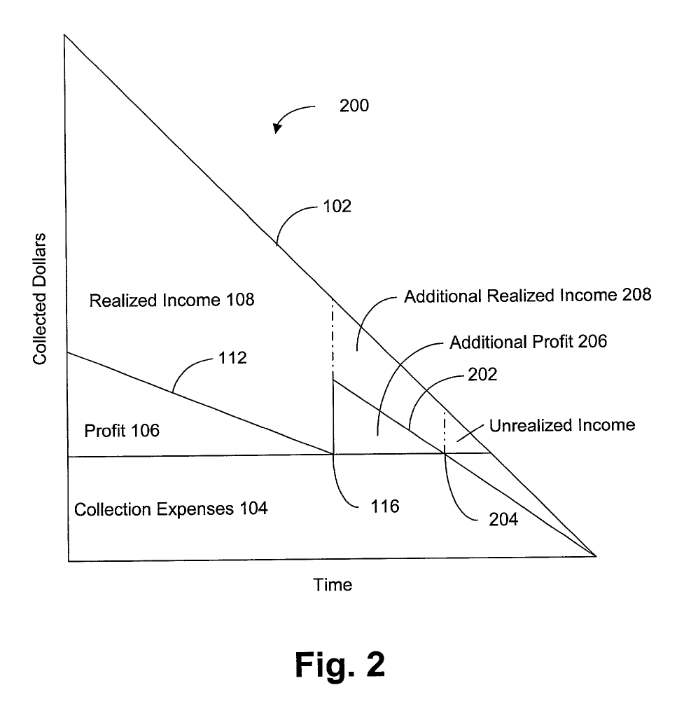

FIG. 2 is a simplified graphical model 200 of the predicted collection of paper over time where first and second consecutive percentage commission rates 112, 202 are employed in accordance with an exemplary embodiment of the present invention. FIG. 2 differs from FIG. 1 by the addition of the second commission rate 202 which results in several significant improvements. The original break-even point 116 which marked where the agency/agent would normally have stopped working the paper now correspond to where the second commission rate 202 begins. The second commission rate 202 has second break-even point 204 which occurs later in time. The additional time working the paper creates additional profit 206 for the collection agency/agent and additional realized income 208 for the paper owner. Thus, the liquidation rate and the profitability of the paper owner have both been increased. Three or more consecutive percentage commission rates may be used.

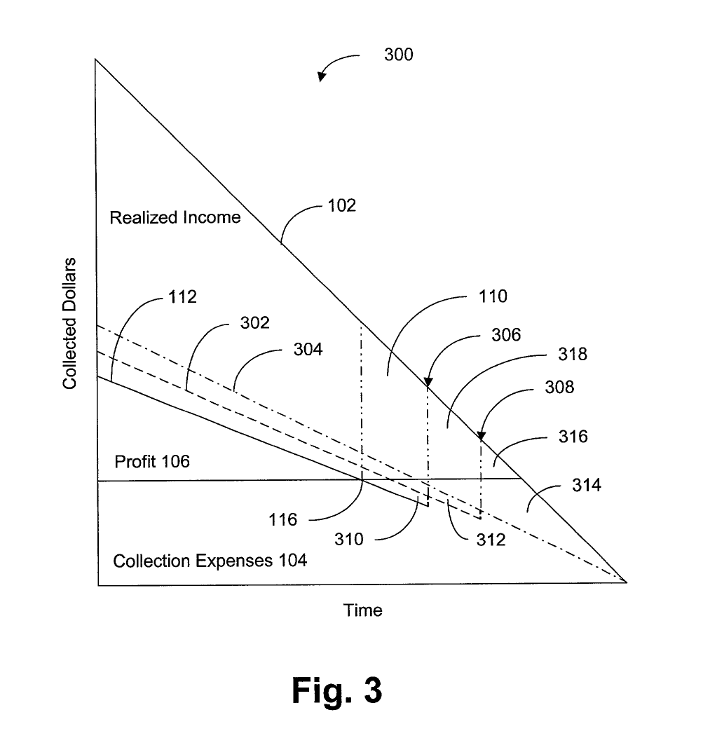

FIG. 3 is a simplified graphical model 300 of the predicted collection of paper over time where the first commission rate 112 is retroactively replaced with progressively larger second and third retroactive commission rates 302, 304. FIG. 3 differs from FIG. 1 by the addition of the second retroactive commission rate 302 and the third retroactive commission rate 304, which result in several significant improvements. The situation in FIG. 3 is similar to that of FIG. 2 in that the agency/agent is motivated to work the paper for a longer period of time. But unlike FIG. 2, the agency/agent is highly motivated to reach a first target collection amount 306 and a second target collection amount 308.

The agency/agent works the paper at the normal first commission rate 112 until reaching the first break-even point 116. The agency/agent would then work the paper at a loss 310 until the first target collection amount 306 is reached. At this point, the second retroactive commission rate 302 would be retroactively applied. The agency/agent would then work the paper at another loss 312 until the second target collection amount 308 is reached. At this point, the third retroactive commission rate 304 would be retroactively applied.

The paper owner through proper selection of the target collection amounts 306, 308 can set the liquidation rate and profitability. All the paper owner needs do is make the next or last commission rate sufficiently profitable so that the agency/agent will work the paper until reaching the target collection amount. The agency/agent will immediately stop working the paper upon reaching the highest target collection amount. Further collection efforts actually result in a substantial loss 314 since the collection expenses 104 are substantially greater than the third retroactive commission rate 304.

The liquidation rate will vary according to the target collection amounts 306, 308. The smallest unrealized income 316 corresponds to best liquidation rate and results when the second target collection amount 308 is reached. It is even possible to set the unrealized income 316 equal to 0. The next smallest unrealized income 318 include the smallest unrealized income 315 and corresponds to next best liquidation rate. The next smallest unrealized income 318 results when the first target collection amount 306 is reached. The largest unrealized income 110 includes the next smallest income 318 and corresponds to worst liquidation rate. The largest unrealized income 110 results when the agency/agent stops working the paper at the break-even point second target collection amount 308 is reached. A single target collection amount or three or more target collection amounts could be used instead of the two target collection amounts 306, 308 shown in FIG. 3. Furthermore, the first commission rate 112 of FIG. 3 could be lower or higher than the collection rate 112 of FIG. 1 instead of being equal, as is shown.

The realized income 318 of FIG. 3 can be varied in any desired manner. The realized income 318 (at the break-even point 116 and the target collection amounts 306, 308) could be made progressively smaller to provide a very large incentive to the agency/agent to work the paper. This would insure high liquidation rates but would reduce profitability of the paper. This embodiment would be used when the liquidation rate is at a premium. For example, when a capital provider lends the paper owner money and tiers the interest rate according to the liquidation rate. Thus, the added expense to increase the liquidation rate can be more than offset by the reducing borrowing costs, which results in greater overall profitability.

The realized income 318 could be set to be substantially constant to provide a large incentive to work the paper and increase the liquidation rate without reducing the profitability of the paper. This embodiment would be used when the liquidation rate produces value but is not at a premium. For example, the paper owner's stock valuation being enhanced by having a better liquidation rate than a competitor.

The realized income 318 could be made progressively larger to provide additional realized income to the paper owner while maintaining an incentive to the agency/agent to work the paper. This would produce additional realized income for the paper owner as compared to the traditional collections and would increase the liquidation rate. The additional realized income would also allow the purchase of another's paper in order to have the paper worked at a profit. The profit would be a portion of the additional realized income. This embodiment opens up new business opportunities and makes old business opportunities more lucrative. The paper owner would also benefit from an increased liquidation rate.

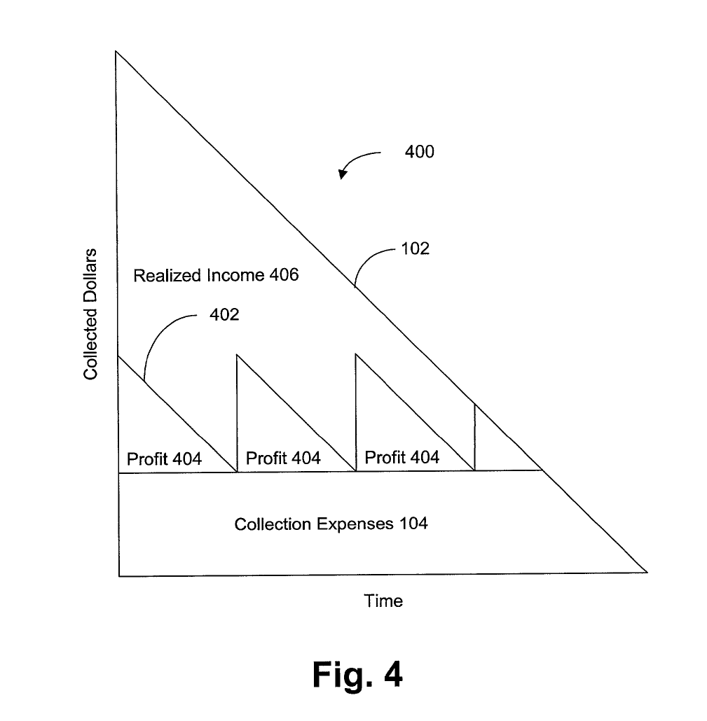

FIG. 4 is a simplified graphical model 400 of the predicted collection of paper over time where a period percentage commission rate 402 is employed in accordance with an exemplary embodiment of the present invention. This embodiment has the advantage that the agency/agent does not see continually diminishing returns on the paper worked. Instead, it is possible for an agency/agent to make an equal amount of profit 404 in any given period. This also provides an incentive for the agency/agent to not cut unnecessary deals on the paper since the agency/agent will wind up making the later commissions more difficult to achieve. An increasing period commission rate could be used where unnecessary deals remain a concern. The collection time may be separated into two or more periods.

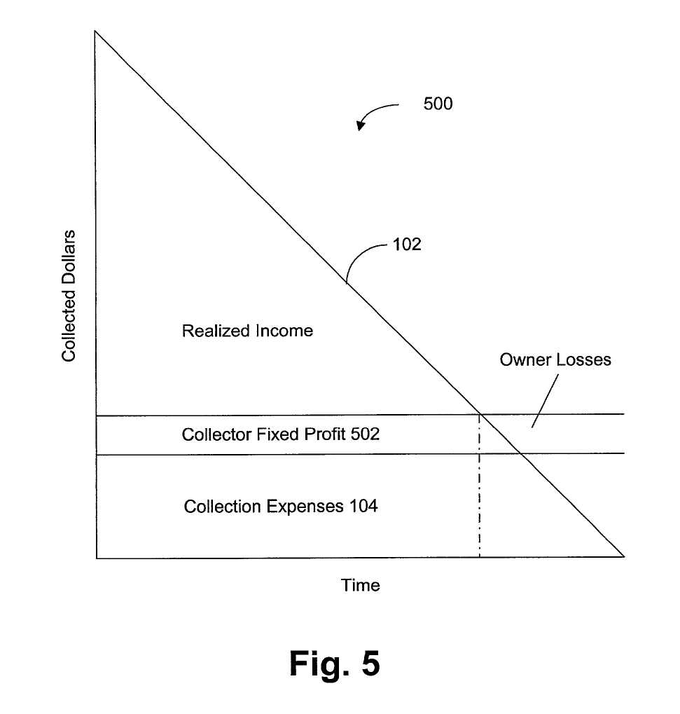

FIG. 5 is a simplified graphical model 500 of the predicted collection of paper over time with a fixed collector profit 502. The margin of profit is smaller than that of commission based collection work since all of the risk lies with the paper owner. This is advantageous to the paper owner at the start of collections where the collected dollars are higher but can be disadvantageous to the paper owner at the end of collections where the collected dollars are lower. This method gives the paper owner direct control over the time or intensity with which a set of paper is worked. This can be combined with commission based collections to prevent the making of unnecessary deals when it is applied at the start of collections or can be combined with commission based collection at the end of collection to further increase the liquidation rate.

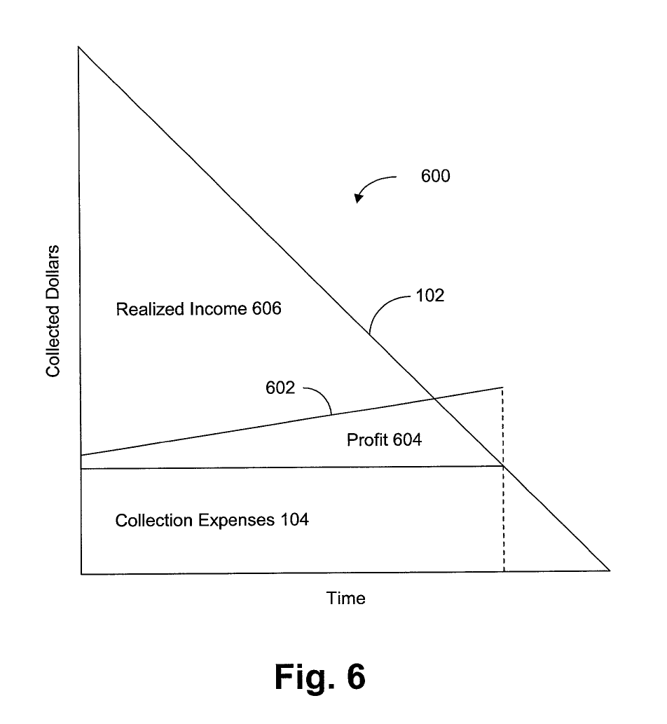

The above collection payment methods may be combined in any number of combinations and permutations. The collection payment method also includes other commission arrangements that increase the profitability, liquidation rate or provide another advantage. For example, FIG. 6 is a simplified graphical model 600 of the predicted collection of paper over time with an increasing total dollar commission 602 with time. The profit 604 consistently gets larger as the paper is worked. Such a commission arrangement would inhibit the making of unnecessary deals since the agency/agent would suffer the most. Unfortunately, other commission arrangements are harder to implement and are less likely to be agreed to by the agency/agent. An agency/agent is less likely to agree to a commission arrangement such as in FIG. 6 since the risk of a bad bunch of paper is front loaded and solely borne by the agency/agent.

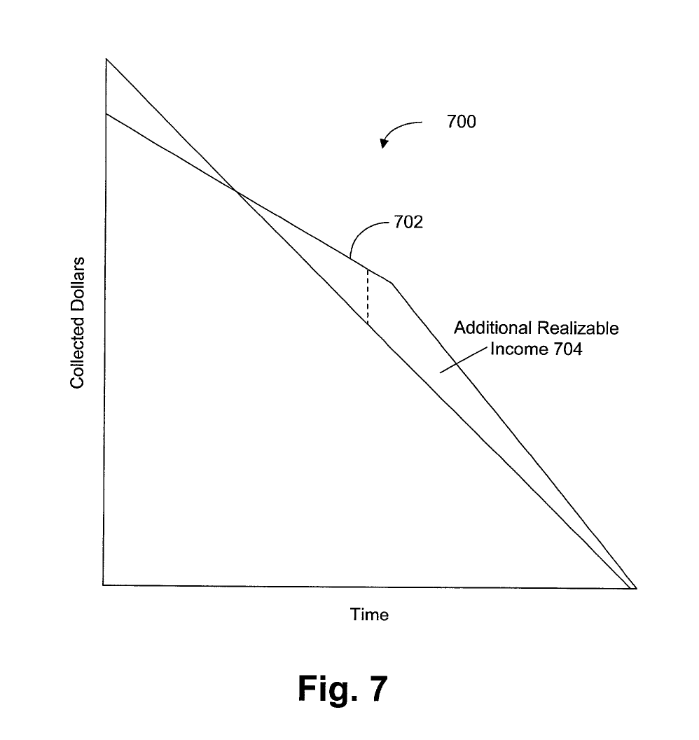

FIG. 7 is a simplified graphical model 700 of the predicted collection of paper over time where an agency/agent is instructed to when to make certain deals to increasing the total amount of collectable paper 102. The collection model is used to determine when certain deals should and should not be offered in order to realize an increase in the total collectable paper 704 having additional realizable income 706. For example, agencies/agents often want to cut better deals to save time and increase commissions. This is not necessarily optimal for the paper owner although this does generate realized income for the paper owner. A more optimal result can be produced using the collection model to determine what and when such offers should be made. Alternatively, the agencies/agent might fail to make deals later during collections that later become uncollectable or are collected for less. The instructions when to make certain deals may be combined with the above collection payment methods to produce better realized incomes and liquidation rates.

The above exemplary embodiments of the present invention are most efficient when implemented with a computer. The model may be input into the computer and then periodically or continuously updated. The updating may be performed by computer personnel or may be programmed into the computer program that does the modeling. The approximate cost of debt collection is normally input into the computer. However, it may also be possible for the computer to calculate the approximate cost from other information. The approximate cost and the model are often used to calculate or select which compensation package or combination of compensation packages are optimal for a given set of information. The exact or approximate commissions or other fees then are output or displayed for use by the owner of the debt. Typically, the computer will be used to select between a fixed profit package, a single commission rate package and a plural commission rate package or combination of those packages. The above exemplary embodiments may also be used in conjunction with various types of debt. For example, credit debt including charged off debt and pre-charged off debt, non-credit card debt and purchased debt.

Although several exemplary embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

We claim:

1. A method for increasing collections from a set of debt comprising:
determining a collection model for a set of debt owed by a set of debtors;
approximating of a cost of debt collection; and
setting plural commission rates payable to a collection entity for the set of debt,
wherein the plural commission rates are set in accordance with the cost of debt collection and the collection model of the set of debt.

2. The method of claim 1, wherein the plural commission rates are set to increase an amount of money collected from the set of debt.

3. The method of claim 1, wherein the plural commission rates are set to substantially maximize a profitability for an owner of the set of debt.

4. The method of claim 1, wherein the plural commission rates are set to substantially maximize amount of money collected from the set of debt less the commissions.

5. The method of claim 1, wherein the plural commission rates are applied retroactively.

6. The method of claim 1, further comprising identifying at least one settlement offer through the collection model that is not optimal.

7. The method of claim 6, further comprising setting terms and conditions for the at least one settlement offer.

8. The method of claim 7, wherein the terms and conditions of the at least one settlement offer are advantageous for an owner of the set of debt and are disadvantageous to the collection entity.

9. The method of claim 6, further comprising setting a timing for the at least one settlement offer.

10. The method of claim 9, wherein the timing for at least one settlement offer is advantageous for an owner of the set of debt and is disadvantageous to the collection entity.

11. The method of claim 1, wherein the set of debt is a set of charged off credit card accounts.

12. The method of claim 9, wherein the set of charged off credit card accounts is a segment of charged off credit card accounts having one or more similar collection characteristics.

13. The method of claim 1, wherein the collection model is implemented on a computer and the setting plural commission rates payable is performed by the computer.

14. A method for increasing collections from a set of debt comprising:
determining a collection model for a set of debt owed by a set of debtors;
determining an approximate cost of debt collection; and
selecting a compensation package from a plurality of compensation packages payable to a collection entity for the set of debt in accordance with the approximate cost of debt collection and the collection model of the set of debt.

15. The method of claim 14, wherein the selecting a compensation package selects one or more of a fix profit package, a single commission rate package and a plural commission rate package.

16. The method of claim 15, wherein the selecting a compensation package selects the fixed profit package.

17. The method of claim 15, wherein the selecting a compensation package selects two or more of or more of a fix profit package, a single commission rate package and a plural commission rate package.

18. The method of claim 14, wherein the selecting a compensation package increases an amount of money collected from the set of debt.

19. The method of claim 14, wherein the selecting a compensation package substantially maximizes a profitability for an owner of the set of debt.

20. The method of claim 14, further comprising determining a compensation package cost associated with each of the plurality of compensation packages,
wherein the selecting a compensation package substantially maximizes amount of money collected from the set of debt less the compensation package cost.

21. The method of claim 14, wherein the collection model for a collection entity is implemented on a computer and selecting a compensation package is performed by the computer.

22. A computer implemented system for increasing collections from a set of debt comprising:
inputting a collection model for a set of debt owed by a set of debtors into a computer;
inputting an approximate cost of debt collection into the computer;
performing a calculation to determine plural commission rates payable to a collection entity for the set of debt in accordance with a cost of collecting the set of debt and the collection model of the set of debt using the computer; and
outputting the plural commission rates.

23. The system of claim 22, wherein the plural commission rates increase as an amount of money collected increases.

24. The system of claim 22, wherein the calculation substantially maximizes a profitability for an owner of the set of debt.

25. The system of claim 22, wherein the calculation substantially maximizes an amount of money collected from the set of debt less the commissions.

26. The system of claim 22, wherein the plural commission rates are to be applied retroactively.

27. The system of claim 22, further comprising performing another calculation with the computer to identify any settlement offers that are not optimal.

28. The system of claim 22, wherein the set of debt is a set of charged off credit card accounts.

29. The system of claim 28, wherein the set of charged off credit card accounts is a segment of charged off credit card accounts having one or more similar collection characteristics.

30. A method for increasing collections from a set of charged off credit card accounts using a computer comprising:
determining a collection model for a set of charged off credit card accounts owed by a set of credit card holders;
determining an approximate cost for collection of the charged off credit card accounts; and
setting plural commission rates payable to a collection agency for the set of charged off credit card accounts,
wherein the plural commission rates are set in accordance with the cost of charged off credit card account collection and the collection model of the set of charged off credit card accounts.

31. A method for increasing collections from a set of charged off credit card accounts using a computer comprising:
determining a collection model for a set of charged off credit card accounts owed by a set of credit card holders;
determining an approximate cost of charged off credit card account collection; and
selecting a compensation package from a plurality of compensation packages payable to a collection entity for the set of charged off credit card accounts in accordance with the approximate cost of charged off credit card account collection and the collection model of the set of charged off credit card accounts,
wherein the selecting a compensation package selects one or more of a fix profit package, a single commission rate package and a plural commission rate package.

32. A computer implemented system for increasing collections from a set of charged off credit card accounts comprising:
inputting a collection model for a set of charged off credit card accounts owed by a set of charged off credit card account holder into a computer;
inputting an approximate cost of charged off credit card account collection into the computer;
performing a calculation to determine plural commission rates payable to a collection entity for the set of charged off credit card accounts in accordance with a cost of collecting the set of charged off credit card accounts and the collection model of the set of charged off credit card accounts using the computer; and
outputting the plural commission rates.
